(19) United States
(12) Patent Application Publication
(10) Pub. No.: US 2015/0182402 A1
(43) Pub. Date: Jul. 2, 2015

(54) Devices and Methods for Lift Assistance and Waste Control

(71) Applicant: LiftSeat Corporation, Lombard, IL (US)

(72) Inventors: Jeffrey Cogan Nelson, Chicago, IL (US); Gregory Charles Kilgore, Aurora, IL (US)

(21) Appl. No.: 14/548,283

(22) Filed: Nov. 19, 2014

Related U.S. Application Data
(60) Provisional application No. 61/906,317, filed on Nov. 19, 2013.

(51) Int. Cl. A61G 7/10; A47K 11/04

(52) U.S. Cl. CPC A61G 7/1007; A47K 11/04; A61G 2200/34

(57) ABSTRACT

Devices and methods are disclosed which relate to lifting a user from a seated position to a raised position. This is performed by incorporating a lifting mechanism into a seat coupled to a movable base portion. As the lifting portion lifts the seat, an angle of the seat changes from a substantially horizontal position to a relatively angled position, mimicking the natural motion of the hips and thighs for humans needing assistance. Embodiments disclosed include using the device as a bedside toilet, having a removable bucket attached to the seat, or using the device placed over a toilet. The removable bucket may be a drop-in commode bucket, or a splash guard having no bottom for use over the toilet. The seat may be built flush to a seating platform base, enabling easy cleaning, and accommodating users of various shapes and sizes.

This application claims priority to U.S. Provisional Patent Application Ser. No. 61/906,317, filed Nov. 19, 2013, the content of which is hereby incorporated by reference herein its their entirety into this disclosure.

### BACKGROUND OF THE SUBJECT DISCLOSURE

1. Field of the Subject Disclosure

The subject disclosure relates to techniques for lifting. In particular, the subject disclosure relates to devices and methods for lifting humans from a seated position to a raised position and vice versa.

2. Background of the Subject Disclosure

The process of sitting or standing is one of the most common and routine movements for human beings. The human body is designed to be able to perform such movement with minimal effort. However, such movements, which are routine for most people, are not so routine for certain classes of people. For example, the elderly, the disabled, the obese, the pregnant, or the weak may have considerable difficulty standing or sitting. Other persons who typically have no problem with the movement of sitting or standing could also have temporary difficulty after surgery or injury. Thus, there are many situations where persons will have temporary or permanent difficulty with the routine process of sitting or standing.

Conventional devices exist in the market to assist with the movement required for sitting or standing. For example, standard crutches are typically used as an anchoring bar to hold and pull during the motion. However, a major drawback of using standard crutches is the need for considerable upper body strength to support a substantial portion of the body weight during the process of sitting or standing. Also, crutches tend to move with the shift of weight, and can often slip at the most crucial time, when the person using them is supporting all of his or her weight on the crutches. Such movement can result in injury to the person using these crutches.

Another conventional device is a standard walker, which is a simple U-shaped device typically having four wheels that allow a user to walk with and lean against the device during movement. Although a walker is really designed to aid in walking movement, it can also be used in the same manner as a crutch, i.e., as an anchor during the motion of standing or sitting. Although the walker is typically more stable than standard crutches because it is self-supporting, the walker can still topple over if enough force or pull is exerted to tip the device over during motion. The walker also needs considerable upper body strength on the part of the user. Thus, there is still some risk of injury to the person using the walker during such motion.

Finally, a few conventional devices have been made that assist a person in standing from a sitting position. However, these devices are typically not designed specifically for a toilet seat and have a one way axis of motion, resulting in a sudden jerk movement that could potentially cause harm or injury to an already weakened, fragile, or injured body, as well as require additional vertical motion which a user may not have the strength to provide.

Thus, there is a need in the art for a simple and universal device to assist in the lifting of humans, by raising and lowering the person gently in a natural and fluid manner. The device should be simple to use, efficient, safe and able to be installed in a relatively short period of time.

### SUMMARY OF THE SUBJECT DISCLOSURE

The subject disclosure solves the above problems by incorporating a lifting mechanism into a seat coupled to a movable base portion. As the lifting portion lifts the seat, an angle of the seat changes from a substantially horizontal position to a relatively angled position, mimicking the natural motion of the hips and thighs for humans needing assistance. Actuators coupled to drive shafts enable a plurality of linkages to be raised and tilted, enabling the seat to rise at the push of a button or other triggering mechanism. A plurality of compressible springs enables an even balance between the weight of the human and the pressure of the lifting mechanism underneath the seat. The device can be used as a bedside toilet, having a removable bucket attached to the seat, or placed over a toilet, and can accordingly be height-adjusted to fit most existing toilets or users. The removable bucket may be a drop-in commode bucket for portable bedside use. Alternatively, the removable bucket may be a splash guard having no bottom for use over the toilet. The seat may include a transfer seat that is built flush to a seating platform base, enabling easy cleaning, and accommodating users of various shapes and sizes. The entire device may have wheels with low profile locking brakes for ease of transport and safety, respectively.

### BRIEF DESCRIPTION OF THE DRAWINGS

FIG. 1 shows a system for lifting with cover in place, according to an exemplary embodiment of the present subject disclosure.

FIG. 2 shows a system for lifting with cover removed, according to an exemplary embodiment of the present subject disclosure.

FIG. 3 shows a commode bucket with lid, according to an exemplary embodiment of the present subject disclosure.

FIG. 4 shows a commode bucket without lid, according to an exemplary embodiment of the present subject disclosure.

FIG. 5 shows a splash guard, according to an exemplary embodiment of the present subject disclosure.

### DETAILED DESCRIPTION OF THE SUBJECT DISCLOSURE

The subject disclosure presents a novel technique for lifting users from a seated position to a substantially standing position without suffering from some of the drawbacks of conventional devices. A lifting mechanism is coupled between a seat portion and a movable base portion. The apparatus can be used as a bedside toilet, having a removable bucket attached to the seat, or placed over a toilet, and can accordingly be height-adjusted to fit most existing toilets or users. The removable bucket may be a drop-in commode bucket for portable bedside use. Alternatively, the removable bucket may be a splash guard having no bottom for use over the toilet. The seat may be built flush to a seating platform base, enabling easy cleaning, and accommodating users of various shapes and sizes. The entire device may have wheels with low profile locking brakes for ease of transport and safety, respectively.

The present subject disclosure includes and incorporates by reference herein in their entirety the following prior filed applications:

U.S. application Ser. No. 11/747,160, filed May 10, 2007, and

U.S. application Ser. No. 12/784,263, filed May 20, 2010.

It should be noted that one of many unique distinctions of the present subject disclosure over conventional approaches is the natural movement that results from the disclosed lifting mechanism. Considering the natural motion of a person who is about to sit from a standing position, the lifting mechanism enables a lowering and moving backwards of the person with respect to the person's standing position. Thus, there is not only a relative vertical change in position but also a horizontal change in torso or “core” position, with the torso being supported from below (on a vertical axis), even while lowering, as well as from behind (on a horizontal axis). In studying such natural motion, the subject disclosure is designed to mimic such motion to a degree that the device actually lowers and backs a user during the resting motion, and conversely, raises and pushes the user gently during the lifting process.

As used herein and throughout this disclosure, the term “lift” is defined as a relative change in elevation, such as a relative lifting or lowering or other movement of a portion of a body from one position to the next. Lifting is a movement from a lowered or seated position into a raised or standing position. The opposite of lifting is lowering, i.e., from a standing position to a seated position. However, the word lifting as used herein and throughout this disclosure should be construed to include both raising and lowering motions. As applied to the subject disclosure, exemplary devices and methods assist in lifting a user, resulting in either a relative raising or relative lowering of the body or portion thereof from one position to the next.

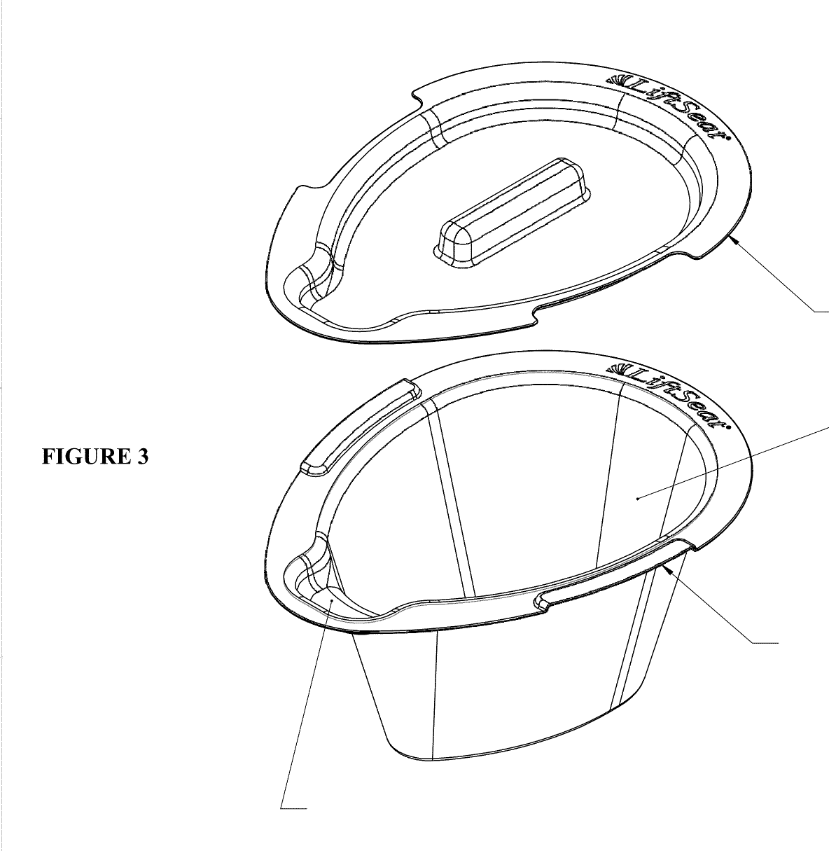

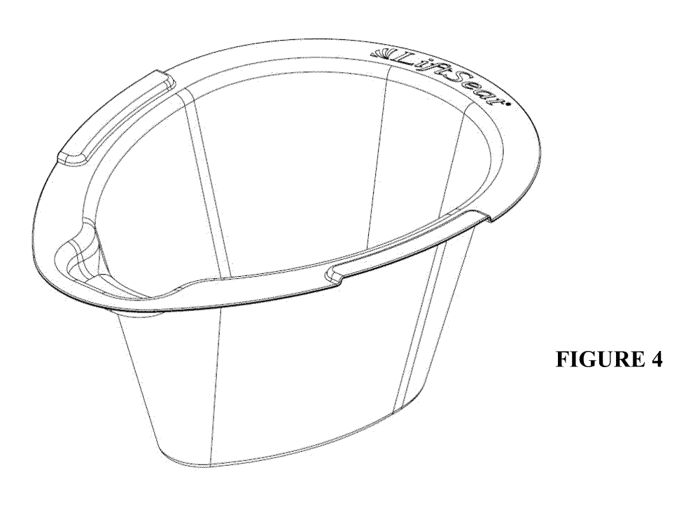

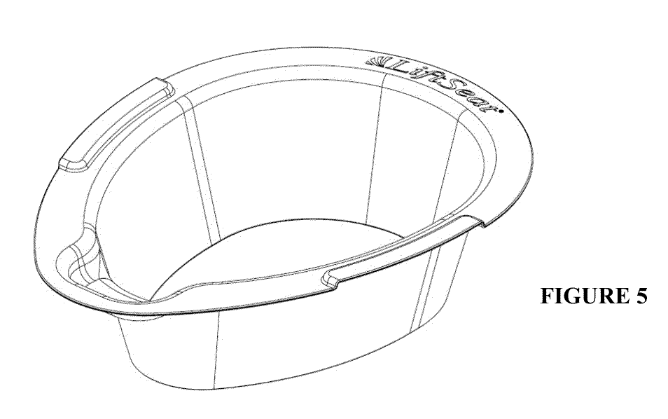

A drop-in commode bucket (FIGS. 3 and 4) or splash-guard (FIG. 5) may have a funnel-like shape, and may be formed of any material which is at least semi-rigid. For instance, plastic or rigid paper material may be used. Paper material may be ideal in situations in which the drop-in commode bucket or splash-guard is to be disposed of. Plastic material may be washed and reused. A ridge around the drop-in commode bucket or splash guard serves to secure it within a hole in a seat portion of a lift assist device. The bottom of the drop-in commode bucket or splash guard may be cut out, such that it functions as a funnel, for instance, to funnel waste into a toilet below the lift assist device. The drop-in commode bucket or splash guard may alternatively be formed into any shape, so long as it secures to a seat portion of a lift assist device in a position allowing waste to flow into it.

Alternatively, the material may be a fabric/paper combination such that the entire drop-in commode and any potential collection within it are completely disposable in a toilet or other collection device. Alternatively, the bottom of the drop in commode bucket is closed to allow collection of the waste material therein. Alternatively, graded notches can be provided to allow for measurement of the volume of waste material. Related embodiments include a catheterization device coupled to the lift-assist device. Alternatively, the commode bucket can include ports to be connected to drainage systems such that emptying is not required and cleaning is only performed when necessary. Other embodiments include a urine guard for male users. Related embodiments include an LED or similar lighting mechanism to illuminate the toilet surface such that a user can operate the device at night without risk of falling.

The exemplary embodiments described herein, as well as any further conceivable versions, are all designed to be rigid in frame and stable to prevent undesired movement of the device during the lifting or lowering motion. This can be achieved by lowering a center of gravity, building a wider base portion relative to a seat portion, etc. The center of gravity can be lowered by appropriate placement of heavier components such as batteries, actuators, motors, etc. This decreases the chances for injuries that may occur as a result of the loss of stability of the device. Further, the motion of the lifting mechanism is designed to be smooth, effortless, and reflective of the natural ergonomic motion of the body, so as to decrease the risks of injury to the body that are possible during an unnatural or jerky motion, as is common in conventional devices. This is achieved by a combination of actuators, linkages, and compressible springs that connect the base portion to the seat portion. Moreover, various combinations of shrouds can be used as protective walls that can serve to protect the arms, legs, and other appendages of a user from any contact with moving parts of the device. The shrouds and covers also help easy cleaning of the device, such as being hosed or wiped down, without concern for disturbing or moving any critical components.

The use of the present device has been described with respect to a user in general. As briefly described above, such user may be elderly, handicapped, or otherwise incapacitated. However, the subject disclosure is not limited to such persons but can be used by anyone who desires assistance in movement from one position to another. For example, an obese individual may have significant difficulty in standing up from a laying or sitting position, but has little trouble walking once standing. The use of this device assists the obese individual in standing without aid from another individual. Besides moving from a seated position to a raised position, the subject disclosure has the potential to be used to assist persons to move from a substantially horizontal position (e.g., lying down or supine) to a sitting and/or standing position, and vice versa. In general, the subject disclosure may be used to assist a person in any relative movement from a portion or all of the body being in a substantially horizontal to a substantially inclined or vertical position, and vice versa. Other changes in body position assistance are also possible through the subject disclosure. Thus, use of the subject disclosure results in both cost savings (obese individual can stand and sit without aid worker, no potential injury to aid worker, etc.) and preservation of dignity and sense of autonomy for the user. These advantages are applicable to other users of the device as well, other than obese individuals.

The subject disclosure is not only limited to persons who are permanently weakened, diseased or physically affected. For example, the subject disclosure may also be used by individuals who have temporary injuries or conditions, such as persons with sport or accidental injuries that cause difficulty moving or standing. Also, persons using crutches have difficulty standing and sitting and can also benefit from the subject disclosure. Another class of individuals who can greatly benefit from assistance in standing and sitting include pregnant women, who often have difficulty in such otherwise routine motions. The adjustable features of the subject disclosure, including adjustable controls, allow a person's performance to improve during the rehabilitation process, enabling dynamic physical therapy and recovery.

Thus, because so many different types of people with different conditions, limitations or needs can benefit greatly from the use of the subject disclosure, lifting devices according to the subject disclosure may be incorporated virtually anywhere where such motion can potentially occur, including the home, businesses, motorized vehicles and the like. The above embodiments discuss the lift-assist device being used over a standard toilet and anchored in place so as to minimize any unwanted movement of the device during the lifting motion. In this application, the lifting device can serve to lift and lower toilet seat to aid a user who cannot perform these motions without assistance. When the lifting device is installed on a toilet it is important to note that this and many other embodiments of the lifting device do not depend on the toilet for support. The embodiment is free standing and has enough strength to support itself and a person sitting on top. As such, installation of the lifting device is not permanent, and can be relocated.

The lift device according to the subject disclosure can also be incorporated in many other environments with slight changes in the shape of the components; such slight changes are those as would be known to one having ordinary skill in the art. Examples include vehicle seats, seats in the home (chairs, couches, sofas, beds, toilets, showers, etc.), seats in business environments (physician offices, examination rooms, waiting areas, stadiums, arenas, theaters, restaurants, airplanes, buses, etc.) and anywhere else where such a device would be beneficial, such places become more apparent to one having ordinary skill in the art in light of the above disclosure. Changes in shape and components are anticipated within the subject disclosure and all such changes are within the scope of the subject disclosure. Such changes can include a movable back rest support, detachable seats, padded seats, adjustable and removable handlebars and push bars, and the ability to meet specific requirements such as those of the American Disabilities Act (ADA). Changes can also be made to meet different weight requirements of different users, such as a larger weight requirement for users with bariatric problems, etc.

An attachment, entitled “Appendix A” on its first page, which shows various improvements and features of an exemplary lift seat device described herein, is attached hereto and is hereby incorporated by reference herein in its entirety.

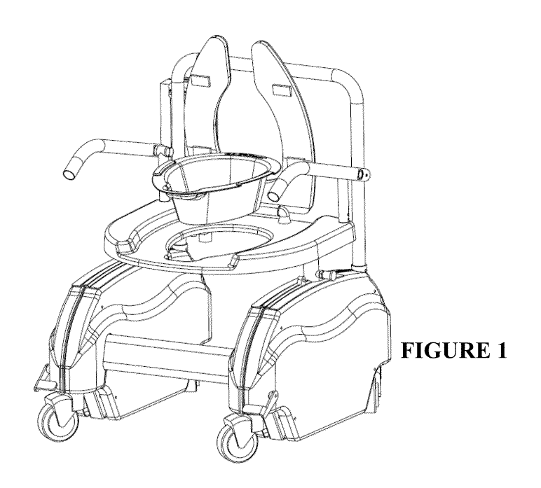

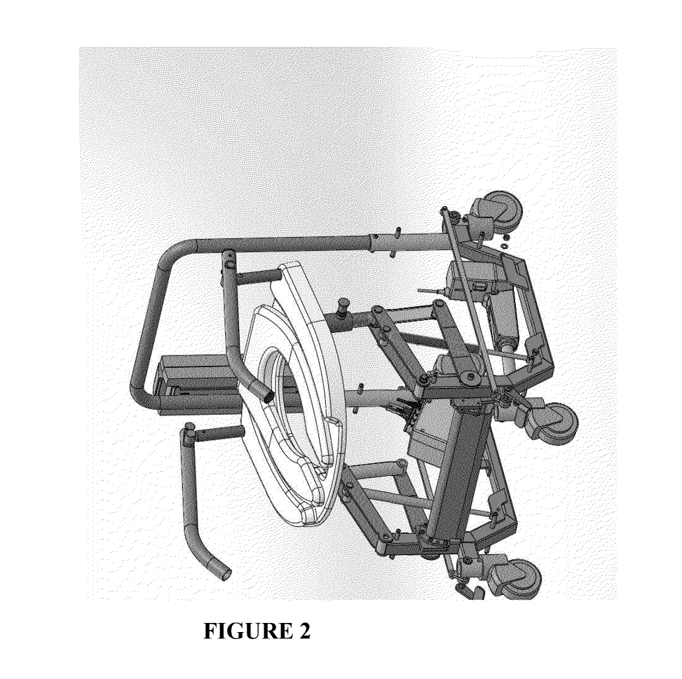

In one exemplary embodiment, a system is shown in FIGS. 1-2. The system has a general exterior structure which includes various components. A seating platform is generally parallel to the ground and includes raised sides that are generally in the same plane as the top portion of the seat to allow for easy transfer of a patient across the raised side and on to the seat. A higher elevated seat allows for compliance with current requirements for taller toilets. The seat platform itself can raise and lower as needed to become compatible with virtually any toilet height and size system. A handheld controller positioned at an end of the flexible coil is attachable to various parts of the exterior structure to allow for easy and convenient access. The controller allows for raising/lowering and other control movements. The handheld controller provides virtually limitless reach and access to the control buttons, as opposed to systems with buttons in fixed locations, which may not be accessible by users or patients because of physical or space limitations. Further flexibility in movement is provided by the sturdy, but swivel locking wheels. They wheels allow motion of the system in any direction, and once a desired location is found, the wheels are easily locked to prevent any further movements of the system. For example, during time of patient loading and unloading onto the system, it is desirable for the system to remain locked in position, which is achievable by locking the wheels. Further, it may be helpful to lock the wheels when a patient is positioned over the toilet to prevent any potential movement during use of the toilet. During time of movement of the patient in place and positioning over the toilet, it is desirable to have the wheels unlocked.

In another exemplary embodiment, a commode bucket is shown in FIGS. 3 and 4, and a splash guard is shown in FIG. 5. These disposable items are designed to fit within the system shown in FIGS. 1 and 2. They can easily be replaced after every use and serve to protect the system from waste and contamination.

The foregoing disclosure of the exemplary embodiments of the subject disclosure has been presented for purposes of illustration and description. It is not intended to be exhaustive or to limit the subject disclosure to the precise forms disclosed. Many variations and modifications of the embodiments described herein will be apparent to one of ordinary skill in the art in light of the above disclosure. The scope of the subject disclosure is to be defined only by the claims appended hereto, and by their equivalents.

Further, in describing representative embodiments of the subject disclosure, the specification may have presented the method and/or process of the subject disclosure as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the subject disclosure should not be limited to the performance of their steps in the order written, and one skilled in the art can readily appreciate that the sequences may be varied and still remain within the spirit and scope of the subject disclosure.

What is claimed is:

1. A lift-assist device, comprising:
a horizontal base portion;
a seat aligned flush with the horizontal base portion;
a removable bucket having a ridge that couples to a part of the horizontal base portion underneath the seat;
wherein a lift generator moves the seat from a sitting position to a raised position.

2. The device of claim 1, wherein the removable bucket includes a bottom for receiving and storing bodily wastes.

3. The device of claim 1, wherein the removable bucket has an open bottom for funneling bodily wastes into a toilet.

4. The device of claim 1, further comprising wheels connected to the device to easily transport the device.

5. The device of claim 4, wherein the wheels include low profile brakes for preventing movement of the wheels and securing the device in a given position.

6. A container, comprising:
side walls;
handle portion attached to the side walls;
wherein the side walls and handle portion are adapted to fit into a lifting device.

7. The container of claim 7, further comprising a bottom portion, thereby creating a holding bucket.

8. The container of claim 8, further comprising a lid to cover the bucket.
